(19) United States
(12) Patent Application Publication
(10) Pub. No.: US 2020/0349414 A1
(43) Pub. Date: Nov. 5, 2020

(54) SYSTEMS AND METHODS FOR NEURONAL NETWORKS FOR ASSOCIATIVE GESTALT LEARNING

(71) Applicant: THE REGENTS OF THE UNIVERSITY OF CALIFORNIA, Oakland, CA (US)

(72) Inventors: Maksim Bazhenov, Oakland, CA (US); Seth Haney, Oakland, CA (US); Aiswarya Akumalla, Oakland, CA (US)

(21) Appl. No.: 16/863,969

(22) Filed: Apr. 30, 2020

Related U.S. Application Data
(60) Provisional application No. 62/840,962, filed on Apr. 30, 2019.

(51) Int. Cl. G06N 3/04; G06N 3/08; G06K 9/62

(52) U.S. Cl. CPC G06N 3/0445; G06K 9/6292; G06K 9/629; G06N 3/082

(57) ABSTRACT

Systems and methods for neuronal networks for associative learning are described. For example, a method may include obtaining target content, obtaining conditioned feature extraction models, generating multiple extracted features by applying the conditioned feature extraction models to the target content, obtaining a conditioned integration model, generating a representation of the target content by applying the conditioned integration model to the multiple extracted features, and displaying the representation.

### CROSS-REFERENCE TO RELATED APPLICATIONS

This application claims priority to U.S. Provisional Patent Application No. 62/840,962, filed on Apr. 30, 2019, the content of which is incorporated herein by reference in its entirety.

### GOVERNMENTAL LICENSE RIGHTS

This invention was made with government support under grant no. N00014-16-1-2829 awarded by the Office of Naval Research. The government may have certain rights in the presently disclosed technology.

### TECHNICAL FIELD

Various embodiments generally relate to neuronal networks.

### BRIEF SUMMARY OF EMBODIMENTS

Disclosed are systems and methods that relate to neuronal networks for associative learning. For example, a computer-implemented method for generating a representation may be implemented in a computer system. The computer system may include a physical computer processor, non-transitory storage medium, and a display. The computer-implemented method may include obtaining target content. The target content may include multiple modalities. A given modality may include a feature. The computer-implemented method may include obtaining conditioned feature extraction models. The conditioned feature extraction models may be trained using training feature extraction datasets. A given conditioned feature extraction model may correspond to a given modality. A given training feature extraction dataset may include training content for a given feature and extraction of the given feature. The computer-implemented method may also include generating multiple extracted features by applying the conditioned feature extraction models to the target content. The computer-implemented method may include obtaining a conditioned integration model. The conditioned integration model may be trained using training integration data. The training integration data may include multiple features from different ones of the modalities and links between the multiple features. The computer-implemented method may also include generating the representation of the target content by applying the conditioned integration model to the multiple extracted features. The computer-implemented method may include displaying the representation via the display.

In embodiments, the multiple modalities may include one of a visual, auditory, olfactory, and semantic stream.

In embodiments, the target content may include one of an image, video, text, data, and audio.

In embodiments, the multiple extracted features may include an object in the target content.

In embodiments, the conditioned feature extraction model may include conditioned feature extraction sub-models. A given conditioned feature extraction sub-model may correspond to a given feature.

In embodiments, the conditioned feature extraction model may include one of a CNN, neural network, recurrent neural network, brain-inspired neural network, and processing block.

In embodiments, the conditioned integration model may include one of a Support Vector Machine, softmax function, stacked Boltzmann machine, deep belief network, Long Short Term network, and Gated Recurrent Unit.

In embodiments, the representation may use visual effects to depict at least some of the extracted features in the target content.

In another example, a neuronal network system may include a processor and a non-transitory storage medium coupled to the processor to store instructions. The instructions may be executed by the processor which cause the processor to perform operations. One operation may include obtaining multiple target features derived from target content. Another operation may also include obtaining a conditioned integration model. The conditioned integration model may be trained using training integration data. The training integration data may include multiple features from different modalities and links between the multiple features. Yet another operation may include generating the representation of the target content by applying the conditioned integration model to the multiple target features.

In embodiments, the neuronal network system may further include a display. The non-transitory storage medium may be coupled to the processor to store additional instructions. The additional instruction may be executed by the processor which cause the processor to perform further operations. One operation may include displaying the representation via the display

In embodiments, the different modalities may include two of a visual, auditory, olfactory, and semantic stream.

In embodiments, the multiple target features may include objects in the target content.

In another example, a computer-implemented method for generating feature extraction models may be implemented in a computer system. The computer system may include a physical computer processor and non-transitory storage medium. The computer-implemented method may include obtaining training feature extraction datasets. A given training feature extraction dataset may include training content for a given feature and extraction of the given feature. The computer-implemented method may include obtaining initial feature extraction models. A given initial feature extraction model may correspond to a given modality. The computer-implemented method may also include generating conditioned feature extraction models by training the initial feature extraction models with the training feature extraction datasets. A given conditioned feature extraction model may correspond to a given modality. The computer-implemented method may include storing the conditioned feature extraction models.

In embodiments, the computer-implemented method may further include obtaining target content. The target content may include multiple modalities. A given modality may include a feature. The computer-implemented method may also include generating multiple extracted features by applying the conditioned feature extraction models to the target content. The computer-implemented method may include storing the multiple extracted features.

In embodiments, the computer-implemented method may further include obtaining training integration data. The training integration data may include multiple features from different modalities and links between the multiple features. The computer-implemented method may include obtaining an initial integration model. The computer-implemented method may also include generating a conditioned integration model by training the initial integration model with the training integration data. the computer-implemented method may include storing the conditioned integration model.

In embodiments, the computer-implemented method may further include generating the representation of the target content by applying the conditioned integration model to the multiple extracted features. The computer-implemented method may also include displaying the representation via the display.

In another example, a computer-implemented method for generating an integration model may be implemented in a computer system. The computer system may include a physical computer processor and non-transitory storage medium. The computer-implemented method may include obtaining training integration data. The training integration data may include multiple features from different modalities and links between the multiple features. The computer-implemented method may also include obtaining an initial integration model. The computer-implemented method may include generating a conditioned integration model by training the initial integration model with the training integration data. the computer-implemented method may include storing the conditioned integration model.

In embodiments, the computer system may further include a display. The computer-implemented method may further include obtaining multiple target features derived from target content. The computer-implemented method may include generating the representation of the target content by applying the conditioned integration model to the multiple target features. The computer-implemented method may also include displaying the representation via the display.

In embodiments, the different modalities may include two of a visual, auditory, olfactory, and semantic stream.

In embodiments, the multiple target features may include objects in the target content.

### BRIEF DESCRIPTION OF THE DRAWINCIS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

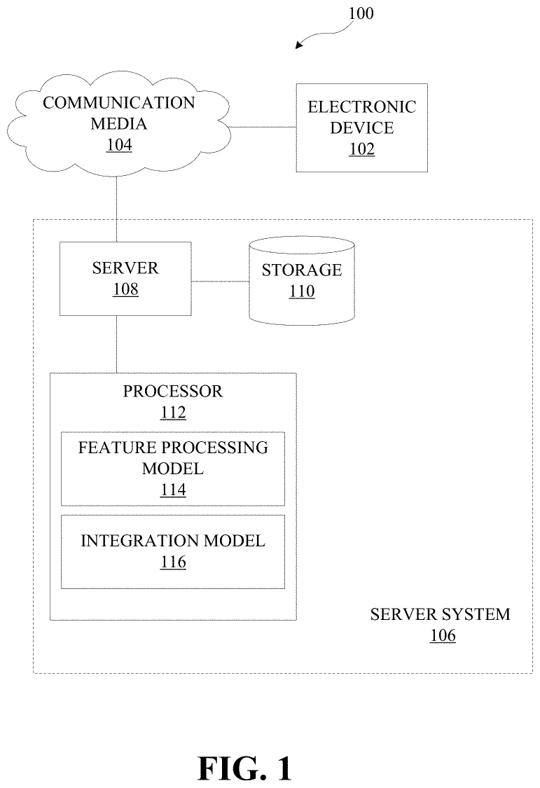

FIG. 1 illustrates an example system for associative gestalt learning , in accordance with various embodiments.

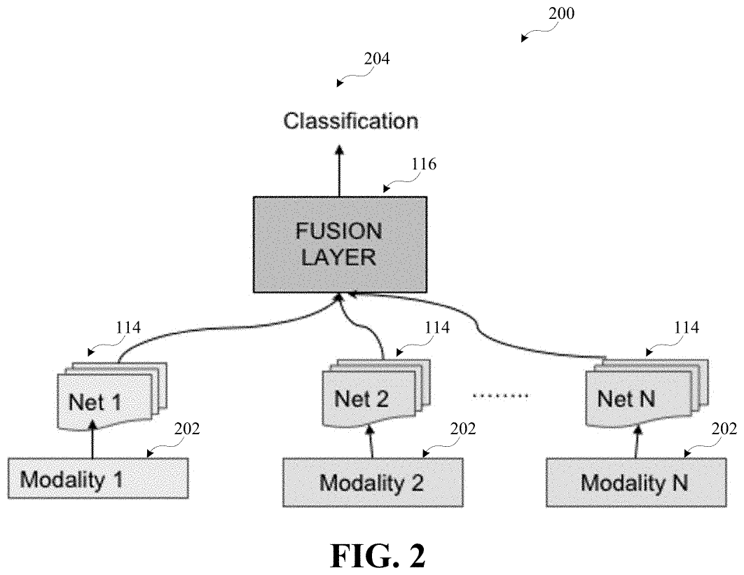

FIG. 2 illustrates an example architecture of a gestalt learning system, in accordance with various embodiments of the present disclosure.

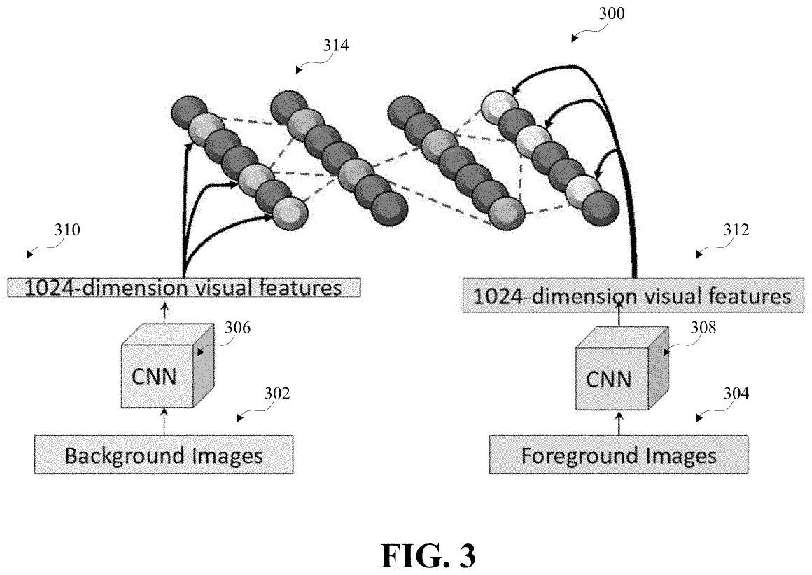

FIG. 3 illustrates an example of using the one or more feature extraction models to process data, in accordance with various embodiments of the present disclosure.

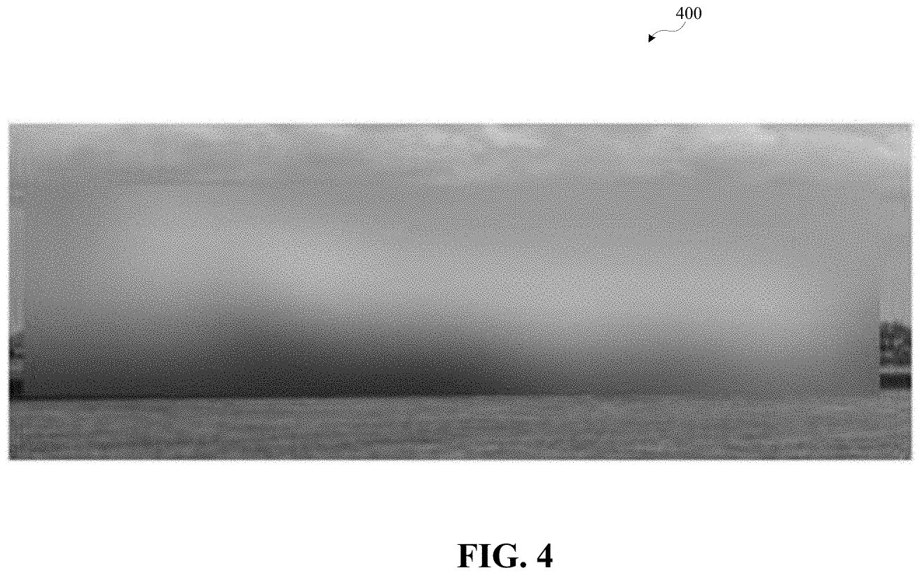

FIG. 4 illustrates an example image generated by using the example gestalt learning system, in accordance with various embodiments of the present disclosure.

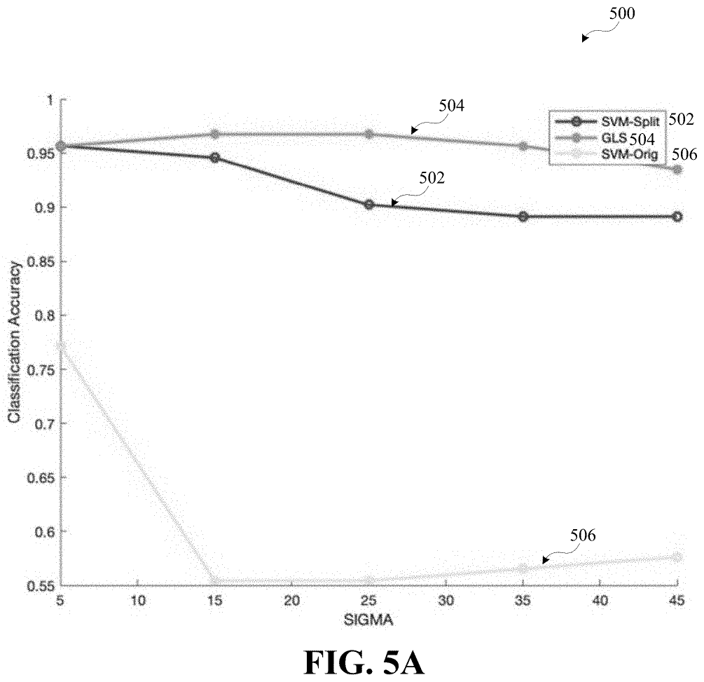

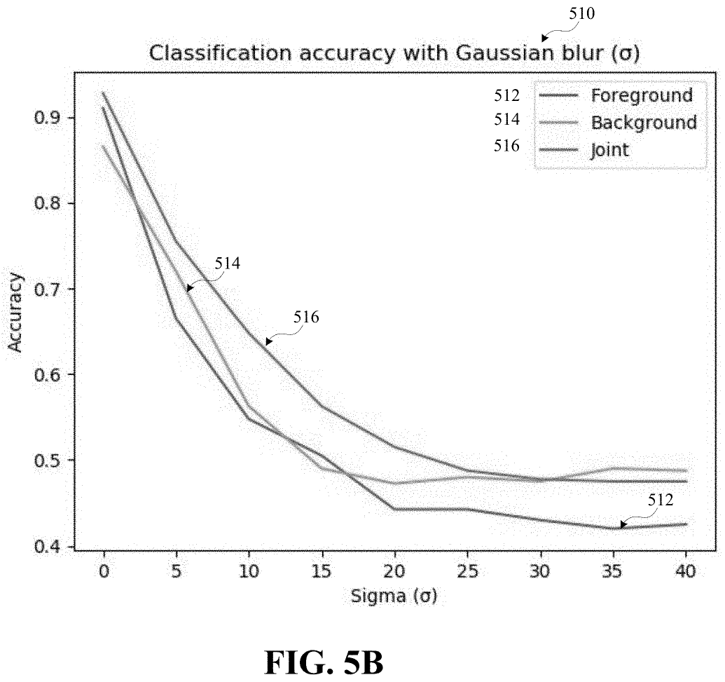

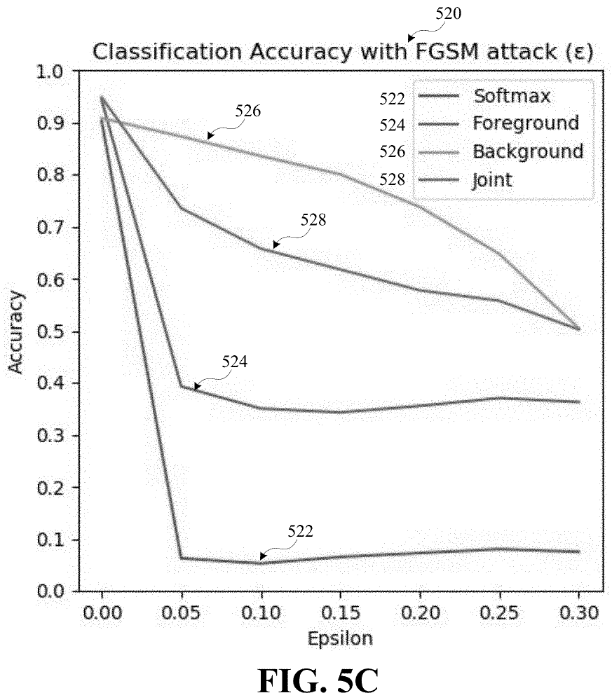

FIG. 5A illustrates a graph corresponding to the classification accuracy of an example gestalt learning system, in accordance with various embodiments of the present disclosure.

FIG. 5B illustrates a graph corresponding to the classification accuracy of the example gestalt learning system, in accordance with various embodiments of the present disclosure.

FIG. 5C illustrates a graph of classification accuracy with an adversarial attack, in accordance with various embodiments of the present disclosure.

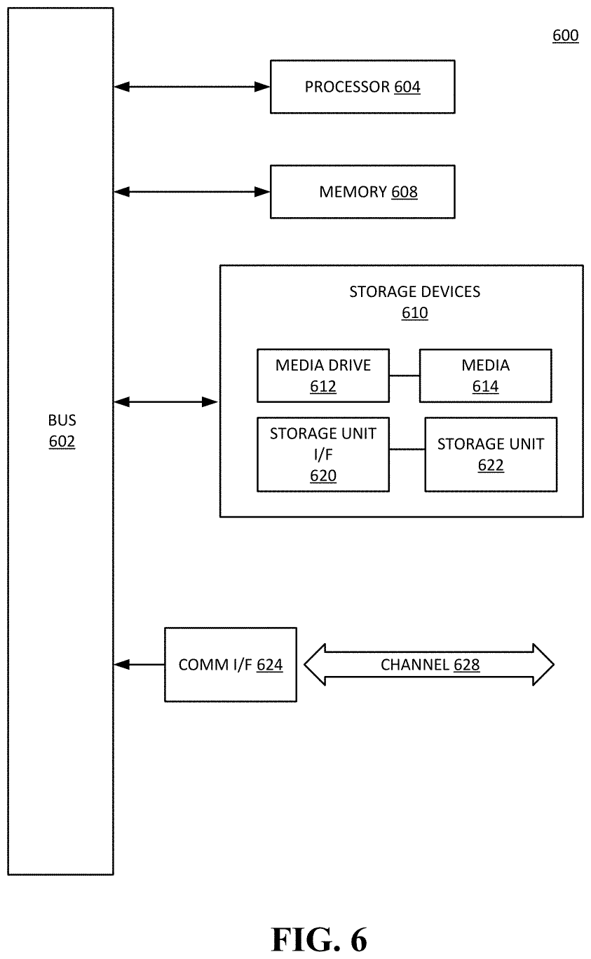

FIG. 6 illustrates an example computing component that may be used to implement features of various embodiments of the disclosure.

The figures are not intended to be exhaustive or to limit the presently disclosed technology to the precise form disclosed. It should be understood that the presently disclosed technology can be practiced with modification and alteration, and that the disclosed technology be limited only by the claims and the equivalents thereof.

### DETAILED DESCRIPTION OF THE EMBODIMENTS

Current deep learning networks (DLNs) may be designed to optimally solve unimodal tasks for a particular input modality (e.g., convolutional neural networks (CNNs) for image recognition), but may be unable to solve tasks that combine different features from multiple modalities (e.g., visual, semantic, auditory, olfactory, and other senses) into one coherent representation. In comparison, biological systems may be able to form unique and coherent representations (as is done in the associative cortex) by combining highly variable features from different specialized cortical networks (e.g., primary visual or auditory cortices). This natural strategy may include superior discrimination performance, stability against adversarial attacks, and better scalability. For example, in the case of adversarial attacks on images, where a very small change in pixel intensities leads to a large decrease in classification success, attacks are targeted to induce misclassification. It has been claimed that adversarial images designed for one type of classifier may also be successful for similar classifiers. However, the multimodal approach disclosed herein combines multiple distinct channels of information, and as such, an adversarial attack against one channel will not be successful against the other channels. Indeed, if a classification decision is made based on a combination of features from different sensory modalities, noisy or missing information in one modality can be compensated by information in another modality to make a correct decision. Furthermore, different types of sensory information can complement each other by being available at different times within a processing window. For example, driving may be a skill which relies on a combination of visual and auditory processing that helps avoid mistakes and enhances performance over only visually based driving.

Classification decisions using the complex mixture of features from different modalities using specialized classifiers in each of them (e.g., visual, semantic, auditory, olfactory, and other senses) is still lacking in existing machine learning (ML) algorithms. Problems include difficulty of training because of the lack of data sets combining different types of information and suboptimal performance of generic DLNs vs specialized ones. Indeed, high performance of the visual processing CNNs is based on their architecture that makes explicit assumptions that inputs are images. The same network performs poorly for auditory processing.

Multimodal fusion may allow access to multiple modalities that observe the same phenomenon for more robust predictions since this allows for complementary information to be captured. Moreover, a multimodal system can still operate when one of the modalities is missing, for example recognizing emotions from the visual signal when the person is not speaking. Multimodal processing still faces the following challenges: 1) fusing information from disparate learned modalities and 2) acquiring a joint representation of a gestalt concept corresponding to components learned by each modality. Learning a coherent representation from two or more modalities such that it is: a) robust to missing inputs; b) has spatial and temporal coherence; c) has sparsity and natural clustering; and d) preserves semantic information is challenging. Computational strategies must fuse, represent, translate, and align multimodal data.

Disclosed are systems and methods for neuronal networks for associative gestalt learning. The presently disclosed technology may fuse high level processed features in the native representation space for each modality. This allows the presently disclosed technology to operate in the high-dimensional cross-product of both feature spaces and make sparse, long-range connections between native representations from multiple modalities. The neuronal system may include a feature extraction model and an integration model. The feature extraction model may process content to detect and identify features of the content. The feature extraction model may separately process different features and/or modalities of the content. The feature extraction model may extract features of the content and learn how to better detect and identify the corresponding feature for each individual feature processor. The extracted features may be used as input for the integration model. The integration model may fuse, or integrate, the multiple extracted features using ML algorithms to detect, identify, and/or classify one or more objects in the content and/or generate a representation of the extracted features. In some embodiments, this detection, identification, and/or classification may include tagging content with relevant metadata, detecting a specific location in the content where the classified data is, presenting markers in a graphical user interface of the classified data, etc. For example, a video of a jungle may include a jaguar in a first frame based on the visual content in the first half of the video. In the second half of the video, jaguar noises may be heard that may be detected and identified such that the entire video is classified as a jaguar video. In embodiments, the representation may use visual effects to depict at least some of the extracted features from the content.

Before describing the technology in detail, it may be useful to describe an example environment in which the presently disclosed technology can be implemented. FIG. 1 illustrates one such example environment 100. Environment 100 may be used in connection with implementing embodiments of the disclosed systems, methods, and devices. By way of example, the various below-described components of FIG. 1 may be used to generate representation and/or classify content based on different modalities. Content may include images, video, text, data, audio, and/or other content. Content may include one or more features. The one or more features may include information on one or more objects captured by the content. Server system 106 may include feature extraction model 114 and integration model 116, as will be described herein. Feature extraction model 114 may detect, identify, and/or extract the one or more features of the content and integration model 116 may integrate the extracted features from different modalities into a cohesive representation that may be used to classify the content.

Feature extraction model 114 may detect, identify, and extract the one or more features of the content. In embodiments, feature extraction model 114 may include multiple sub-models such that a given sub-model may be used to extract a given feature. In some embodiments, a given sub-model may be used to extract features from a given modality. Feature extraction model 114 may use one or more ML algorithms, such as for example, CNNs, neural networks, recurrent neural networks, brain-inspired neural networks, processing blocks, and/or other ML algorithms. Individual ML algorithms may be able to detect and/or identify a given feature based on training content of the same modality as the target content. The training content may correspond to the feature of the individual ML algorithm. Once identified, the corresponding features may be extracted.

Integration model 116 may integrate the extracted features from feature extraction model 114 into a cohesive representation. In embodiments, the different features of the same content may be linked by any ML algorithm of integration model 116 such that the links may be used to identify a relationship for future content that has similar connections. For example, different features extracted from different modalities of a video may be placed on a timeline of the video. For example, three visual features and one audio feature may be linked at the same time. The audio feature may correspond to a first visual feature. An initial ML algorithm may link the three visual features and the one audio feature together. After training the ML algorithm over multiple videos, the ML algorithm may be able to link the first visual feature to the audio feature and to identify this link in future content. In embodiments, the ML algorithm may need to be retrained for each piece of content or related pieces of content. For example, content captured in a first location may be trained together while content captured in a second different location may be trained together. Different locations may mean different surroundings and environments (e.g., city versus country versus jungle versus ocean). In some embodiments, a conditioned ML algorithm of integration model 116 may be applicable to content from different locations.

Electronic device 102 may include a variety of electronic computing devices, such as, for example, a smartphone, tablet, laptop, computer, wearable device, television, virtual reality device, augmented reality device, displays, connected home device, Internet of Things (I0T) device, smart speaker, and/or other devices. Electronic device 102 may present content to a user and/or receive requests to send content to another user. In some embodiments, electronic device 102 may apply feature extraction model 114 and integration model 116 to target content. In embodiments, electronic device 102 may store feature extraction model 114 and integration model 116.

As shown in FIG. 1, environment 100 may include one or more of electronic device 102 and server system 106. Electronic device 102 can be coupled to server system 106 via communication media 104. As will be described in detail herein, electronic device 102 and/or server system 106 may exchange communications signals, including content, metadata (including contextual information), user input, and/or other information via communication media 104.

In various embodiments, communication media 104 may be based on one or more wireless communication protocols such as Wi-Fi, Bluetooth®, ZigBee, 802.11 protocols, Infrared (IR), Radio Frequency (RF), 2G, 3G, 4G, 5G, etc., and/or wired protocols and media. Communication media 104 may be implemented as a single medium in some cases.

As mentioned above, communication media 104 may be used to connect or communicatively couple electronic device 102 and/or server system 106 to one another or to a network, and communication media 104 may be implemented in a variety of forms. For example, communication media 104 may include an Internet connection, such as a local area network (LAN), a wide area network (WAN), a fiber optic network, internet over power lines, a hard-wired connection (e.g., a bus), and the like, or any other kind of network connection. Communication media 104 may be implemented using any combination of routers, cables, modems, switches, fiber optics, wires, radio (e.g., microwave/RF links), and the like. Upon reading the present disclosure, it should be appreciated that other ways may be used to implement communication media 104 for communications purposes.

Likewise, it will be appreciated that a similar communication medium may be used to connect or communicatively couple server 108, storage 110, processor 112, feature extraction model 114, and/or integration model 116 to one another in addition to other elements of environment 100. In example implementations, communication media 104 may be or include a wired or wireless wide area network (e.g., cellular, fiber, and/or circuit-switched connection, etc.) for electronic device 102 and/or server system 106, which may be relatively geographically disparate; and in some cases, aspects of communication media 104 may involve a wired or wireless local area network (e.g., Wi-Fi, Bluetooth, unlicensed wireless connection, USB, HDMI, standard AV, etc.), which may be used to communicatively couple aspects of environment 100 that may be relatively close geographically.

Server system 106 may provide, receive, collect, or monitor information to/from electronic device 102, such as, for example, content, metadata, user input, security and encryption information, and the like. Server system 106 may be configured to receive or send such information via communication media 104. This information may be stored in storage 110 and may be processed using processor 112. For example, processor 112 may include an analytics engine capable of performing analytics on information that server system 106 has collected, received, etc. from electronic device 102. Processor 112 may include feature extraction model 114 and integration model 116 capable of receiving target content, analyzing target content, and otherwise processing target content and generating a cohesive representation that server system 106 has collected, received, etc. based on requests from, or coming from, electronic device 102. In embodiments, server 108, storage 110, and processor 112 may be implemented as a distributed computing network, a relational database, or the like.

Server 108 may include, for example, an Internet server, a router, a desktop or laptop computer, a smartphone, a tablet, a processor, a component, or the like, and may be implemented in various forms, including, for example, in an integrated circuit or collection thereof, in a printed circuit board or collection thereof, or in a discrete housing/package/rack or multiple of the same. Server 108 may update information stored on electronic device 102. Server 108 may send/receive information to/from electronic device 102 in real-time or sporadically. Further, server 108 may implement cloud computing capabilities for electronic device 102. Upon studying the present disclosure, it should be appreciated that environment 100 may include multiple electronic devices 102, communication media 104, server systems 106, servers 108, storage 110, processors 112, feature extraction models 114, and/or integration models 116.

FIG. 2 illustrates an example architecture of a gestalt learning system, in accordance with various embodiments of the present disclosure. As described above, feature extraction model 114 may include multiple sub-models for a given modality and/or feature. Feature extraction models 114 may process different modalities 202 from a piece of content in parallel. Individual ones of modalities 202 may be different information streams representing different aspects of an input content to be learned. These information streams may include (a) different components of the same modality (e.g., background and foreground context of an image, see example below); (b) different modalities (e.g., visual, auditory, olfactory, semantic, and other sensory streams); (c) different types of information, such as, for example, contextual information (e.g., time of day, weather conditions, geographical location) and metadata (e.g., angle at which capture device is positioned, timestamps of captured content, direction of capture device, type of capture device, etc.) or (d) combination of any of these above. In embodiments, individual information streams may be processed independently. In other embodiments, cross talk between individual processing streams may occur. Feature extraction models 114 may include various processing algorithms, such as, for example, artificial neural networks (e.g., CNNs, recurrent neural networks, etc.), brain inspired neural network (e.g., networks of spiking neurons connected by synapses), and/or non-neural based processing blocks. Different types of processing components (e.g., different types of neural networks) may be applied to optimize processing of specific features of input content. Each feature extraction model 114 may learn the features that are specific to the information stream it is designed to be optimally focused on.

Integration component 116 may be referred to as a “Neural Integrator” (NI). The NI may receive specific features learned by individual processing components (e.g., feature extraction models 114) and integrate them to process the content as a whole. The NI may be (a) built based on a brain inspired multi-layer neural network architecture (also known as a “neural network”) with plastic connectivity between units (neurons), (b) built based on any ML design, and/or (c) directly implemented using any existing classifier solutions (e.g., SVM, softmax, etc.). The unimodal feature representations may be extracted using a neural network, as described above, but may not be configured to deal with missing information. Probabilistic graphical models may be used based on, for example, stacked Boltzmann machines or deep belief networks, to compensate for missing information from different modalities. Due to the generative nature of the probabilistic graphical models, missing information from one modality is handled well. For modelling sequential modalities such as text, audio and video, sequential models, such as, for example, Long Short Term networks (LSTM) or Gated Recurrent Units (GRU), may be used to extract feature representations. In these cases, a joint strategy may be used when all the modalities are present during inference—audio-visual speech recognition and/or emotion and multimodal gesture recognition.

Aligning multimodal representations may include aligning subcomponents between modalities with each other. Explicit alignment may be an extension of the coordinated strategy where similarity constraints are imposed on the subcomponents of the modalities. The alignment can be unsupervised (e.g., how dynamic time warping may be used to manually create similarity metrics between visual scenes and sentences based on appearance of same characters to align TV shows and plot synopses). Supervised alignment methods may rely on labelled aligned instances. Supervised alignment methods may be used to train similarity measures that are used for aligning modalities. This may include deep learning based approaches. Implicit alignment may include finding latent relationships between modalities using graphical models and/or neural networks with attention components. An attention component will tell the decoder to look more at targeted sub-components of the source to be translated (e.g., areas of an image, words of a sentence, etc.).

During training phase, the NI may learn associations between features of the input content (e.g., association between images and sounds both made by the same objects or associations between background and foreground components of the same images). During training, the NI may receive unprocessed input or preprocessed data. This may include taking advantage of high-level representations of objects through existing ML algorithms (e.g. AlexNet for classifying images and/or LSTMs for classifying speech). Each of these high-level representations may be projected into a joint space, such as, for example, a neural space, in the NI. After being trained, the conditioned NI may be able to exploit learned representations of objects to predict the category, or class, of corrupted, incomplete, noisy, and/or previously unseen input. Connections learned in the training phase may be exploited to complete corrupted or incomplete content and generate a representation of the features. The output of the NI can be interpreted directly and/or can be used to train another layer of the system—a classifier. The classifier may include existing systems (e.g., softmax or support vector machine (SVM)).

In embodiments, similar to the functioning of human and animal brains, the NI may learn and/or develop links based on different plasticity mechanisms that make small changes of connectivity between neurons involved in the action that led to the desired outcome and/or are frequently repeated during a training phase. Over time, the NI may form a selected set of links between neurons that represent commonly occurring sequences of events and/or desired outcomes from sequences of events. These links may inform the NI how features from various modalities fit together. It should be appreciated that the presently disclosed technology is not limited by these embodiments, and the NI can be implemented using various ML architecture. The presently disclosed technology may be deployed using a local solution and/or a cloud solution.

The presently disclosed technology may include network processing components that can improve classification performance in conditions where specific aspects of an input are noisy and/or partially corrupted. Some examples include: (a) using information about image background to better classify foreground objects; (b) using auditory information, or other sensory information, to compensate for lack of visual information (e.g., when visual stream is obscured); and (c) using contextual information (e.g., geographic location) to improve visual classification performance (e.g., to better identify objects only found in specific locations).

FIG. 3 illustrates an example of using the one or more feature extraction models to process data, in accordance with various embodiments of the present disclosure. In this example application, visual content may be processed based on separation of background 302 and foreground 304 of the visual input. The content may be separated into background 302 and foreground 304. Background 302 and foreground 304 of the input may be processed independently by CNNs 306 and 308 to extract features 310 and 312 specific to each component. Features 310 and 312 extracted may be combined and processed by the neural network into representation 314 of features 310 and 312. Representation 314 may be used to improve classification of the image as a whole. As illustrated, CNNs may be used to extract a representation of visual features. For example, an Alexnet architecture may be used, which has five convolutional layers and three fully connected layers. Two CNN's of the Alexnet architecture may be trained on the backgrounds and foregrounds of images of a training dataset. Transfer learning may be implemented by using these CNN's as fixed feature extractors for two classes: Airplanes (in the sky) and Leopards (in the jungle). As illustrated, a second fully connected layer may be used to extract a 4096-dimensional representation of foreground images and background images of {Airplanes, Leopards} as two input modalities. As used herein, “modalities” may refer to foreground and background of images as two channels of information. The association may be enforced by concatenating both modalities using an early fusion strategy. Thus, an 8192 dimensional representation is obtained for each of the images in the training set.

Model-agnostic and model-based approaches may be two broad categories of existing multimodal fusion. Model-agnostic methods can be split into early fusion (i.e., feature-based), late fusion (i.e., decision-based), and hybrid fusion. Early fusion may integrate features immediately after they are extracted (often by simply concatenating their representations). Late fusion may perform integration after each of the modalities has made a decision (e.g., classification or regression). Finally, hybrid fusion may combine outputs from early fusion and individual unimodal predictors.

Model-based approaches may include multiple kernel learning, neural networks and/or graphical models to extract representations and may include a fusing component that fuses, or otherwise integrates, the information from individual modalities. It should be appreciated that different models and methods may be used in the presently disclosed technology.

FIG. 4 illustrates an example image generated by using the example gestalt learning system, in accordance with various embodiments of the present disclosure. As illustrated, the image blurs an essential foreground object (sigma=15). This is one target set of five target sets, as will be described below, with varying amounts of blur on foreground images using a 2D Gaussian kernel.

FIG. 5A illustrates graph 500 corresponding to the classification accuracy of an example gestalt learning system, in accordance with various embodiments of the present disclosure. As illustrated, classification accuracy varies as Gaussian blur increases for images in the target set. The x-axis (SIGMA) may represent an amount of blur applied to the target set of images. Line 502 may represent an SVM classifier trained on images with feature extraction model using a background network and a foreground network and a corresponding 8192-dimensional representation. Line 504 may represent using a Hopfield network with a SVM classifier trained on images with feature extraction done from the foreground and background network. Line 506 may represent an SVM classifier trained on original images (no separate feature extraction for foreground and background) and a corresponding 4096 dimensional representation.

To provide further detail of the test run to generate graph 500, M may be a number of images in the training set and N may be a number of images in the target set. During feature extraction, M images may be used to train two independent CNN components to become specialized in the background and foreground type of images. At integration, the 8192×M vectors may be processed by the NI. In embodiments, a Hopfield network may be used to store M images that are 8192 dimensions as attractor states/memories. In some embodiments, a continuous version of a Hopfield network may be implemented. Since Hopfield networks may store memories nearby each other, the memories may be combined into a manifold that contains both memories. This may perform implicit clustering for the memories. The gang effects introduced by closely stored attractor patterns deepens the basin of attraction and provides a new way of generalization of the input modalities. The clustered attractor may correspond to “generalized” notions of Airplanes in the sky and Leopards in the jungle. When the dynamical system may be presented with new patterns not stored as attractor states in the network, convergence to the appropriate class may occur.

For each of the N target images, 8192 dimensional representations may be obtained after processing by the trained CNNs. Output 8192 vector may be presented to the Hopfield network. The state of the network and convergence may be obtained after applying attractor dynamics. A SVM may be used to classify the output of the Hopfield network into {Airplanes, Leopards}. During test phase, these images may not overlap with the training content, but may be new images never seen by the Hopfield network during training. Classification accuracy may be the primary performance metric, as illustrated in graph 500. In this context, classification accuracy may denote the proportion of images that an object recognition algorithm recognizes as belonging to a correct class. 100% classification accuracy may be obtained with N=92 images. The procedure described above may be repeated to provide the results in graph 500.

Graph 500 indicates that the presently disclosed technology is robust to naturally occurring image perturbations that humans can perceive—such as blur, whereas linear SVM classifier may misclassify images. Conventional CNN using the whole image may fail to classify images for any level of blur above Sigma=15.

It should be appreciated that in some embodiments, networks and models other than the Hopfield network may be used for the input data and feature extraction. In such cases, contextual fusion as modelled by the gestalt learning system can still improve performance over the unimodal processing.

Contextual fusion could potentially overcome different types of adversaries by learning a representation that is robust to human perceivable noise, (e.g. blur, distortion, compression, and the like) and network perceivable noise, (e.g. white box adversarial attacks and black box adversarial attacks). To demonstrate this further, categories from the MS COCO dataset may be selected that possess distinct foreground and background information that is perceivable in image space. Model architecture may be changed to resnetl8 to show generalization across different architectures. The fusion method may be implemented as feature extraction followed by concatenation at higher level layers. Support Vector Machines may be used as classifiers.

Gaussian blur(G) may be again introduced as a human perceivable adversary. FIG. 5B illustrates the highest classification accuracy from the fused representation referred to as “Joint 516” when compared to the individual modalities referred to as “Foreground 512” and “Background 514”.

Fast Gradient Sign Method (FGSM), is a popular white box adversarial attack on neural networks that uses the model's architecture, parameters, inputs, and outputs to perturb the inputs with noise(e) and to produce misclassifications with high confidence. FIG. 5C shows the performance of “Softmax 522,” “Joint 528,” “Foreground 524,” and “Background 526”. Although the “Joint 528” representation is not the highest performing classifier, it performs significantly better than “Softmax 522” or “Foreground 524” which would normally be used for classification. There is a clear difference in the “Foreground 524” versus “Background 526” classifier's robustness to perturbed inputs. This suggests that a principled way to combine the two, could further improve “Joint 528” performance.

FIG. 6 illustrates an example computing component that may be used to implement features of various embodiments of the disclosure. As used herein, the term component might describe a given unit of functionality that can be performed in accordance with one or more embodiments of the technology disclosed herein. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. As used herein, the term engine may describe a collection of components configured to perform one or more specific tasks. Even though various features or elements of functionality may be individually described or claimed as separate components or engines, one of ordinary skill in the art will understand that these features and functionality can be shared among one or more common software and hardware elements, and such description shall not require or imply that separate hardware or software components are used to implement such features or functionality.

Where engines and/or components of the technology are implemented in whole or in part using software, in one embodiment, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the technology using other computing components or architectures.

Referring now to FIG. 6, computing component 600 may represent, for example, computing or processing capabilities found within desktop, laptop, and notebook computers; hand-held computing devices (FDA's, smart phones, cell phones, palmtops, etc.); mainframes, supercomputers, workstations, or servers; or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, digital cameras, navigation systems, cellular telephones, portable computing devices, modems, routers, WAPs, terminals and other electronic devices that might include some form of processing capability.

Computing component 600 might include, for example, one or more processors, controllers, control components, or other processing devices, such as a processor 604. Processor 604 might be implemented using a general-purpose or special-purpose processing engine such as, for example, a physical computer processor, microprocessor, controller, or other control logic. In the illustrated example, processor 604 is connected to a bus 602, although any communication medium can be used to facilitate interaction with other components of computing component 600 or to communicate externally.

Computing component 600 might also include one or more memory components, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing component 600 might likewise include a read-only memory (“ROM”) or other static storage device coupled to bus 602 for storing static information and instructions for processor 604.

The computing component 600 might also include one or more various forms of information storage device 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, non-transient electronic storage, non-transitory storage medium, a hard disk, a floppy disk, magnetic tape, cartridge, optical disk, a CD or DVD, or other fixed or removable medium that is read by, written to, or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot, a PCMCIA slot and card, and other fixed or removable storage units 622 and interfaces 620 that allow software and data to be transferred from the storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as an Ethernet, network interface card, WiMedia, IEEE 802.XX, or other interface), a communications port (such as for example, a USB port, IR port, RS232 port, Bluetooth® interface, or other port), or another communications interface. Software and data transferred via communications interface 624 might typically be carried on signals, which can be electronic, electromagnetic (which includes optical), or other signals capable of being exchanged by a given communications interface 624. These signals might be provided to communications interface 624 via channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 608, storage unit 620, media 614, and channel 628. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing component 600 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning, and configurations can be implemented to implement the desired features of the technology disclosed herein. Also, a multitude of different constituent component names other than those depicted herein can be applied to the various partitions. Additionally, with regard to flow diagrams, operational descriptions, and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for generating a representation, the method being implemented in a computer system, the computer system comprising a physical computer processor, non-transitory storage medium, and a display, the computer-implemented method comprising:
obtaining, from the non-transitory storage medium, target content, wherein the target content comprises multiple modalities, and wherein a given modality comprises a feature;
obtaining, from the non-transitory storage medium, conditioned feature extraction models, wherein the conditioned feature extraction models are trained using training feature extraction datasets, wherein a given conditioned feature extraction model corresponds to a given modality, wherein a given training feature extraction dataset comprises training content for a given feature and extraction of the given feature;
generating, with the physical computer processor, multiple extracted features by applying the conditioned feature extraction models to the target content;
obtaining, from the non-transitory storage medium, a conditioned integration model, wherein the conditioned integration model is trained using training integration data, and wherein the training integration data comprises multiple features from different ones of the modalities and links between the multiple features;
generating, with the physical computer processor, the representation of the target content by applying the conditioned integration model to the multiple extracted features; and
displaying the representation via the display.

2. The computer-implemented method of claim 1, wherein the multiple modalities comprise one of a visual, auditory, olfactory, and semantic stream.

3. The computer-implemented method of claim 1, wherein the target content comprises one of an image, video, text, data, and audio.

4. The computer-implemented method of claim 1, wherein the multiple extracted features comprise an object in the target content.

5. The computer-implemented method of claim 1, wherein the conditioned feature extraction model comprises conditioned feature extraction sub-models, wherein a given conditioned feature extraction sub-model corresponds to a given feature.

6. The computer-implemented method of claim 1, wherein the conditioned feature extraction model comprises one of a CNN, neural network, recurrent neural network, brain-inspired neural network, and processing block.

7. The computer-implemented method of claim 1, wherein the conditioned integration model comprises one of a Support Vector Machine, softmax function, stacked Boltzmann machine, deep belief network, Long Short Term network, and Gated Recurrent Unit.

8. The computer-implemented method of claim 1, wherein the representation uses visual effects to depict at least some of the extracted features in the target content.

9. A neuronal network system, comprising:
a processor; and
a non-transitory storage medium coupled to the processor to store instructions, which when executed by the processor, cause the processor to perform operations, the operations comprising:
obtaining, from the non-transitory storage medium, multiple target features derived from target content;
obtaining, from the non-transitory storage medium, a conditioned integration model, wherein the conditioned integration model is trained using training integration data, and wherein the training integration data comprises multiple features from different modalities and links between the multiple features; and
generating, using the physical computer processor, the representation of the target content by applying the conditioned integration model to the multiple target features.

10. The system of claim 9, further comprising a display, and wherein the non-transitory storage medium is coupled to the processor to store additional instructions, which when executed by the processor, cause the processor to perform further operations, the further operations comprising displaying the representation via the display

11. The system of claim 9, wherein the different modalities comprise two of a visual, auditory, olfactory, and semantic stream.

12. The system of claim 9, wherein the multiple target features comprise objects in the target content.

13. A computer-implemented method for generating feature extraction models, the method being implemented in a computer system, the computer system including a physical computer processor and non-transitory storage medium, the computer-implemented method comprising:
obtaining, from the non-transitory storage medium, training feature extraction datasets, wherein a given training feature extraction dataset comprises training content for a given feature and extraction of the given feature;
obtaining, from the non-transitory storage medium, initial feature extraction models, wherein a given initial feature extraction model corresponds to a given modality;
generating, using the physical computer processor, conditioned feature extraction models by training the initial feature extraction models with the training feature extraction datasets, wherein a given conditioned feature extraction model corresponds to a given modality; and
storing, in the non-transitory storage medium, the conditioned feature extraction models.

14. The computer-implemented method of claim 13, further comprising:
obtaining, from the non-transitory storage medium, target content, wherein the target content comprises multiple modalities, and wherein a given modality comprises a feature;
generating, with the physical computer processor, multiple extracted features by applying the conditioned feature extraction models to the target content; and
storing, in the non-transitory storage medium, the multiple extracted features.

15. The computer-implemented method of claim 14, further comprising:
obtaining, from the non-transitory storage medium, training integration data, wherein the training integration data comprises multiple features from different modalities and links between the multiple features;
obtaining, from the non-transitory storage medium, an initial integration model;
generating, using the physical computer processor, a conditioned integration model by training the initial integration model with the training integration data; and
storing the conditioned integration model.

16. The computer-implemented method of claim 15, further comprising:
generating, with the physical computer processor, the representation of the target content by applying the conditioned integration model to the multiple extracted features; and
displaying the representation via the display.

17. A computer-implemented method for generating an integration model, the method being implemented in a computer system, the computer system including a physical computer processor and non-transitory storage medium, the computer-implemented method comprising:
obtaining, from the non-transitory storage medium, training integration data, wherein the training integration data comprises multiple features from different modalities and links between the multiple features;
obtaining, from the non-transitory storage medium, an initial integration model;
generating, using the physical computer processor, a conditioned integration model by training the initial integration model with the training integration data; and
storing the conditioned integration model.

18. The computer-implemented method of claim 17, wherein the computer system further comprises a display, the computer-implemented method further comprising:
obtaining, from the non-transitory storage medium, multiple target features derived from target content;
generating, with the physical computer processor, the representation of the target content by applying the conditioned integration model to the multiple target features; and
displaying the representation via the display.

19. The computer-implemented method of claim 17, wherein the different modalities comprise two of a visual, auditory, olfactory, and semantic stream.

20. The computer-implemented method of claim 17, wherein the multiple target features comprise objects in the target content.
